(19) United States
(12) Patent Application Publication
(10) Pub. No.: US 2008/0195525 A1
(43) Pub. Date: Aug. 14, 2008

(54) Systems and Methods for Clustered Auctioning

(76) Inventor: Amit Orgad, Duluth, GA (US)

Correspondence Address: MALAS LAW, LLC, 400 PERIMETER CENTER TERRACE, NE, SUITE 900, ATLANTA, GA, 30346, US

(21) Appl. No.: 12/028,645

(22) Filed: Feb. 8, 2008

Related U.S. Application Data
(60) Provisional application No. 60/888,907, filed on Feb. 8, 2007.
(60) Provisional application No. 60/888,910, filed on Feb. 8, 2007.

(51) Int. Cl. G06Q 30/00

(52) U.S. Cl. 705/37

(57) ABSTRACT

A method for clustered auctioning includes assigning respective parameter values to respective auction items in an auction, and determining a winner of at least one of the auction items responsive to a parameter value of another auction item in the auction.

### CROSS-REFERENCE

This application claims priority to U.S. Provisional Patent Application No. 60888907 titled “Membership Based Progressive Discount Product Sales System & Method of Use Thereof” filed on Feb. 8, 2007, which is hereby incorporated by reference in its entirety. This application also claims priority to U.S. Provisional Patent Application No. 60888910 titled “Clustered or Grouped Regular & Reverse Auction System” filed on Feb. 8, 2007, which is hereby incorporated by reference in its entirety.

### BACKGROUND

Regular and reverse auctions using mobile SMS short messaging system and web interfaces are gaining momentum worldwide. The promotional value of the reverse auction is becoming more apparent and an increasing number of companies are offering various types of regular and reverse auctions. When running a regular or reverse auction it is often difficult to meet a desired participation goal (e.g., number of bids or level of survey participation) prior to the end of the auction.

### SUMMARY

Systems and methods for clustered auctioning are disclosed. An embodiment of a method for clustered auctioning includes assigning respective parameter values to respective auction items in an auction, and determining a winner of at least one of the auction items responsive to a parameter value of another auction item in the auction.

Other systems, methods, features, and advantages of the present systems and methods will be or become apparent to one with skill in the art upon examination of the following drawings and detailed description. It is intended that all such additional systems, methods, features, advantages, and be included within the scope of this disclosure.

### BRIEF DESCRIPTION OF THE DRAWINGS

The present systems and methods can be better understood with reference to the following figures. The components within the figures are not necessarily to scale, emphasis instead being placed upon clearly illustrating principles associated with clustered auctioning. Moreover, in the figures, like reference numerals designate corresponding parts throughout the different views.

FIG. 1 is a block diagrams illustrating a communication system in accordance with exemplary embodiments.

FIG. 2 is a flowchart illustrating a method for clustered auctioning in accordance with exemplary embodiments.

FIG. 3 is a block diagram illustrating a customer device in accordance with exemplary embodiments.

FIG. 4 is a block diagram illustrating an auction system in accordance with exemplary embodiments.

### DETAILED DESCRIPTION

When conducting an auction, an auction objective may be to achieve or exceed a revenue and/or participation goal within a desired time frame. Exemplary embodiments enable an auction owner or manager to more quickly achieve an auction goal for the highest order item (e.g., most expensive) while the lower order products (e.g., less expensive) are still available. As less products are available, the remaining auction goals needed to release them is also reduced. The highest order product would only require a relatively low additional number of bids or auction participants after the lower products are awarded.

An auction may end after a predetermined time and/or when a predetermined goal is achieved. For example, an auction may end after at least a certain number of bids are received. Time estimates on auction closure dates can be made available in advance based on projected auction participation levels. The auction closure dates may subsequently be modified based on actual auction participation levels.

According to exemplary embodiments, a group of products is auctioned as a cluster or group. Bids, participation or any other goals set by the auction manager may be monitored for the entire cluster. The clustered items may be ordered based on a selected parameter such as, for example, cost, retail value, or market value. Each item in the cluster is then assigned an auction goal that is responsive to the selected parameter. The auction goal may, for example, represent a total number of auction bids or auction participants required to cover the cost of the item and/or achieve a certain profit margin.

After the auction goal for the highest order item (e.g., having highest cost, retail value, or market value) is achieved, the lowest order item (e.g., having lowest cost, retail value, or market value) is awarded to a winning auction participant. After the auction goal for the second highest ordered item is achieved in addition to the auction goal for the highest ordered item, then the second lowest ordered item is awarded. This process continues until the auction goal for the lowest ordered item is achieved in addition to the auction goals for the other items thereby resulting in the highest ordered item being awarded.

Exemplary embodiments for clustered auctioning may be useful when one or more of the following auction circumstances apply:
a. Participants (e.g., customers, users, etc) do not pay the full value of an offering (e.g., product, service, etc).
b. Participants are required to join a program (e.g., by performing an action, paying a premium, and/or performing a sequence of events).
c. The values of individual offerings vary greatly such as, for example, where one offering has a value that is ten or more times greater than another offering. For example, a first offering is a television valued at $5,000 while another offering is a car valued at $50,000.
d. The participation requirements are similar for each of the offerings. For example, participation in an auction requires participants to fill out similar surveys and an Nth participant receives one of the offerings either for free or at a highly discounted price.
e. Auction participation can be measured in a similar manner (e.g., counting survey participants) for each of the offerings. If the participation requirements and/or values are different (e.g., where different surveys are being conducted) then a weighting factor may be applied accordingly.

A weighting factor may be applied where an auction participation can be achieved through different participation requirements such as, for example, where different surveys are being conducted. To illustrate the application of weighting factors, assume that for a first survey, participant number 5000 receives a television valued at $5,000, and that for a second survey, participant number 10,000 receives a vehicle valued at $50,000. In this example, the commercial entity conducting the surveys may receive, for example, $1 for each participation in the first survey and $5 for each participation in the second survey. A weight assigned to each participation may be correlated to the corresponding value received. For example, a weight factor of 1 may be assigned to a first survey participation and a weight factor of 5 may be assigned to a second survey participation when being counted toward an auction goal.

According to exemplary embodiments, a high level of participation is attracted while the most valuable offerings are still available and can be marketed and promoted. In this manner, a sufficient level of participation can be achieved for a high value offering in a shorter period of time. When a target participation level corresponding to a highest valued offering is achieved, then a lowest value offering is awarded. When a target participation level corresponding to a second-highest valued offering is further achieved (in addition to the prior achieved target level), then a second lowest-valued offering is awarded. Additional offerings are then awarded in an ordered manner as additional target participation levels are achieved. The highest-valued offering is awarded after the target participation level is also reached for the lowest-valued offering. In other words, the highest-valued offering is awarded after all the cumulative target participation level is achieved for the offerings in the clustered auction.

Note that a relatively low incremental participation level is required for awarding the highest-valued offering after the second-highest-valued offering is awarded. In this manner, after lower monitory value offerings have been distributed, higher monitory value offerings can be distributed relatively quickly. As a results, multi-offering promotional or paid participation programs may be completed more rapidly while requiring lower advertising and marketing costs.

According to exemplary embodiments, winners may be determined in accordance with rules corresponding to various desired auction styles. Examples of auction styles include a reverse auction cluster, a regular auction cluster, a bingo cluster, and a random raffle cluster, among others. In a reverse auction cluster, a participant is declared a winner if the participant has the lowest unique bid for an offering at the time it is released. In a variation on the reverse auction cluster a participant is declared a winner if the participant has the closest bid to a predetermined value (published or un-published) at the time the offering is released. In a regular auction cluster a participant is declared a winner if the participant has the highest bid for an offering at the time it is released. Variations on the regular auction cluster include where a participant is determined to be a winner if the participant has the highest unique bid or where the participant has the second highest bid, depending on a desired implementation. In a Bingo cluster, a participant is declared a winner if the participant is the last person to achieve a “Bingo” prior to the offering being released. Only a predetermined number of preceding draws are valid at any given time. In a random raffle cluster, a participant is determined to be a winner if the participant has the raffle number that is equal to the winning raffle number prior to the offering being released.

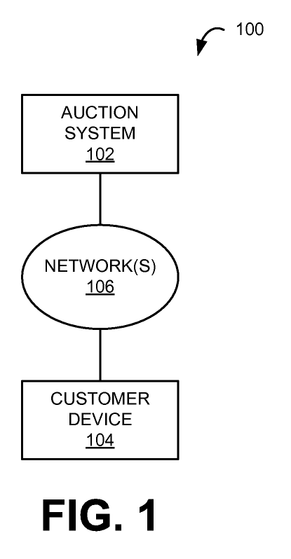

FIG. 1 is a block diagrams illustrating a communication system 100 in accordance with exemplary embodiments. The communication system 100 includes a auction system 102 that is communicatively coupled to one or more customer devices 104 via one or more networks 106. The auction system 102 may comprise one or more computers such as, for example, desktop computers, laptop computers, and/or servers. Note that some alternative embodiments of clustered auctioning may be implemented (partly or entirely) manually (i.e., without the use or computers), depending on a desired implementation.

The customer device 104 may be located remotely from the auction system 102 or may alternatively be located in close proximity to the auction system 102. The customer device 104 may comprise, for example, a desktop computer, a laptop computer, a personal digital assistant (PDA), a television, a television communication terminal, a mobile wireless communication device (e.g., mobile phone), a tablet PC, a remote control device, and/or a landline telephone. The customer device 104 may belong to a corresponding customer or may be made available to the customer by a merchant or vendor when the customer visits an auction location.

The networks 106 may include, for example, the Internet, a public switched telephone network (PSTN), a satellite communication network, a cable television network, a local area network (LAN), and/or a mobile wireless communication network. A type of network 106 used may depend on the type of customer device 104 and the location of the customer device 104 relative to the auction system 102.

Communications used by customers for participating in an auction may involve various formats and/or protocols depending on the type of customer device 104, communication networks 106, and/or desired implementations. Customer communications may involve, for example, SMS (short messaging system), IVR (intelligent voice recognition), HTTP (hypertext transfer protocol), and/or WAP (wireless application protocol). Auction-related information received by a customer computer 102 may comprise textual, graphical, and or audio data, depending on a communication device being used by a customer and/or a desired implementation. Customer communications may additionally or alternatively involve face to face and/or telephone interaction with an auction representative.

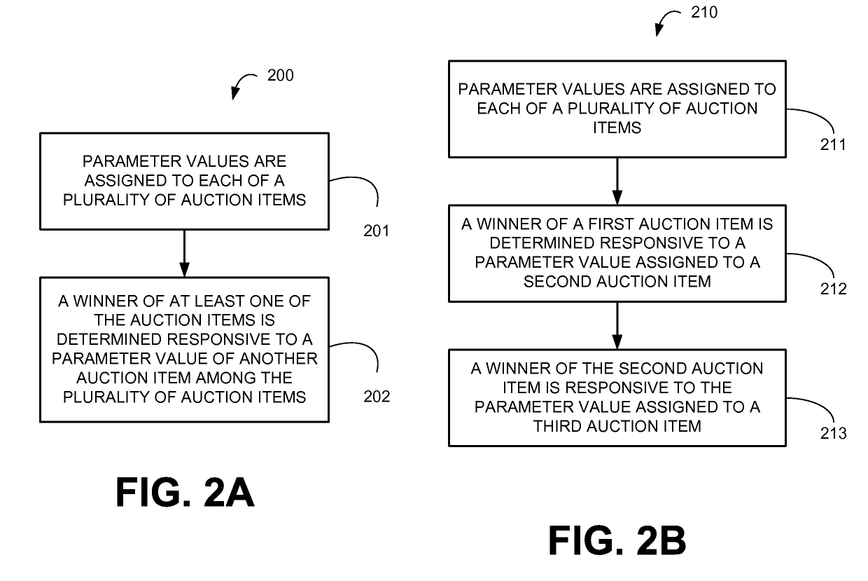

FIG. 2A is a flowchart illustrating a method 200 for clustered auctioning in accordance with exemplary embodiments. As indicated in block 201, parameter values are assigned to each of a plurality of auction items. A winner of at least one of the auction items is then determined responsive to a parameter value of another auction item among the plurality of auction items, as indicated in block 202.

For example, assume that a first clustered auction includes the following: product A having cost A1, product B having cost B1, product C having cost C1, and product D having cost D1, where D1>C1>B1>A1 (i.e., product D has the highest cost). In this first clustered auction, product A is assigned an auction goal (i.e., parameter value) of A2, product B is assigned an auction goal of B2, product C is assigned an auction goal of C2, and product D is assigned an auction goal of D2, where D2>C2>B2>A2. Therefore product D becomes the highest ordered product while product A becomes the lowest ordered product as shown in Table 1, below.

TABLE 1
Example showing auction goals for corresponding products

| Order | Product | Cost | Auction Goal |
|---|---|---|---|
| 1 | D | D1 | D2 |
| 2 | C | C1 | C2 |
| 3 | B | B1 | B2 |
| 4 | A | A1 | A2 |

The auction goals of A2, B2, C2, and D2 may be based on the costs of A1, B1, C1, and D1 respectively. For example, A2, B2, C2, and D2 may correspond to respective levels of auction participation required to recoup the costs A1, B1, C1, and D1, plus achieve a certain profit margin, if desired. In this example, after the highest auction goal D2 is achieved, product A (the lowest ordered and lowest cost product) is awarded. Then after auction goal C2 is achieved in addition to auction goal D2, product B is awarded. After auction goal B2 is further achieved, then product C is awarded. Finally after the lowest auction goal A2 is achieved, the product D (the highest ordered and highest cost product) is awarded.

FIG. 2B is a flowchart illustrating a method 210 for clustered auctioning in accordance with exemplary embodiments. Parameter values are assigned to each of a plurality of auction items, as indicated in block 211. A winner of a first auction item is then determined responsive to a parameter value assigned to a second auction item, as indicated in block 212. A winner of the second auction item is then determined responsive to the parameter value assigned to a third auction item, as indicated in block 213.

For example, assume that a clustered reverse auction campaign includes three products to be awarded, that the cost of a bid in the auction is equal to one dollar, and that each product is won by the lowest unique corresponding bid. The products to be awarded include a television valued at $10,000, a motorcycle valued at $30,000, and a car valued at $50,000. Assuming that a goal of the auction is to generate twice the value of the products to be awarded, then auction goals (i.e., parameter values) may be assigned as follows: 20,000 bids for the television, 60,000 bids for the motorcycle, and 100,000 bids for the car. In this manner, the total auction goals are 180,000 bids valued at $180,000 which is twice the total value of the three products (i.e., twice $90,000).

Continuing with this example, after 100,000 bids are received for the three products, the television reverse auction ends and the television is awarded to an auction winner (e.g., the bidder having the lowest unique bid for the television). Then, after an additional 60,000 bids are received for the remaining two products, the motorcycle reverse auction ends and the motorcycle is awarded to an auction winner. Finally, when an additional 20,000 bids are received for the car, the car reverse auction ends and the car is awarded to an auction winner.

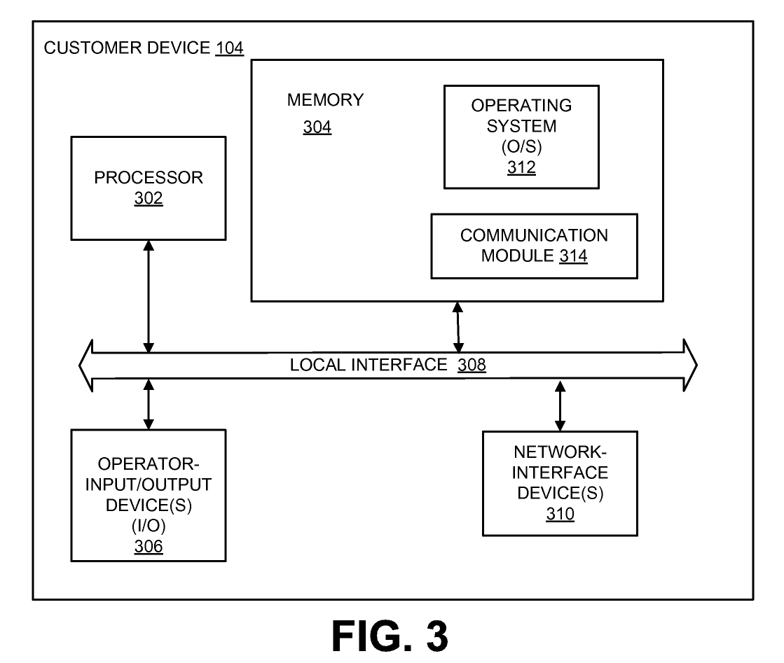

FIG. 3 is a block diagram illustrating a customer device 104 in accordance with exemplary embodiments. In the example illustrated in FIG. 3, the customer device 104 comprises a computing device such as, for example, a desktop computer, a laptop computer, a PDA, or a tablet PC. Note that some alternative embodiments of clustered auctioning may be implemented without a customer device 104.

The customer device 104 includes a processor 302, memory 304, network interface device(s) 310, and one or more user input and/or output (I/O) device(s) 306 (or peripherals) that are communicatively coupled via a local interface 308.

The local interface 308 can be, for example but is not limited to, one or more buses or other wired or wireless connections, as is known in the art. The local interface 308 might have additional elements, which are omitted for simplicity, such as controllers, buffers (caches), drivers, repeaters, and receivers, to enable communications. Further, the local interface 308 might include address, control, and/or data connections to enable appropriate communications among the aforementioned components.

The processor 302 is a hardware device for executing software, particularly that stored in memory 304. The processor 302 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 304 can include any one or combination of volatile memory elements (e.g., RAM, such as DRAM, SRAM, SDRAM, etc.) and nonvolatile memory elements (e.g., ROM, flash memory, etc.). Moreover, the memory 304 might incorporate electronic, magnetic, optical, and/or other types of storage media. Note that the memory 304 can have a distributed architecture, where various components are situated remote from one another, but can be accessed by the processor 302.

The user I/O device(s) 306 includes input devices such as, for example but not limited to, a keyboard, mouse, scanner, microphone, a touch sensitive display etc. Furthermore, the user I/O device(s) 306 also include output devices such as, for example but not limited to, a printer, display, etc. The network interface device(s) 310 include, for example, a modem, a radio frequency (RF) or other transceiver, a telephonic interface, an Ethernet interface, a bridge, and/or a router.

Software stored in memory 304 may include one or more separate programs, each one of which comprises an ordered listing of executable instructions for implementing logical functions. In the example of FIG. 3, the software in the memory 304 includes operating system 312 and a communication module 314. Among other things, the

The communication module 314 may be a source program, executable program (object code), script, or any other entity comprising a set of instructions to be performed. When implemented as a source program, the communication module 314 is translated via a compiler, assembler, interpreter, or the like, which may or may not be included within the memory 304, so as to operate properly in connection with the O/S 312. Furthermore, the communication module 314 can be written in one or more object oriented programming languages, which have classes of data and methods, or procedure programming languages, which have routines, subroutines, and/or functions. In an embodiment, other communication software can be used, depending on a desired implementation.

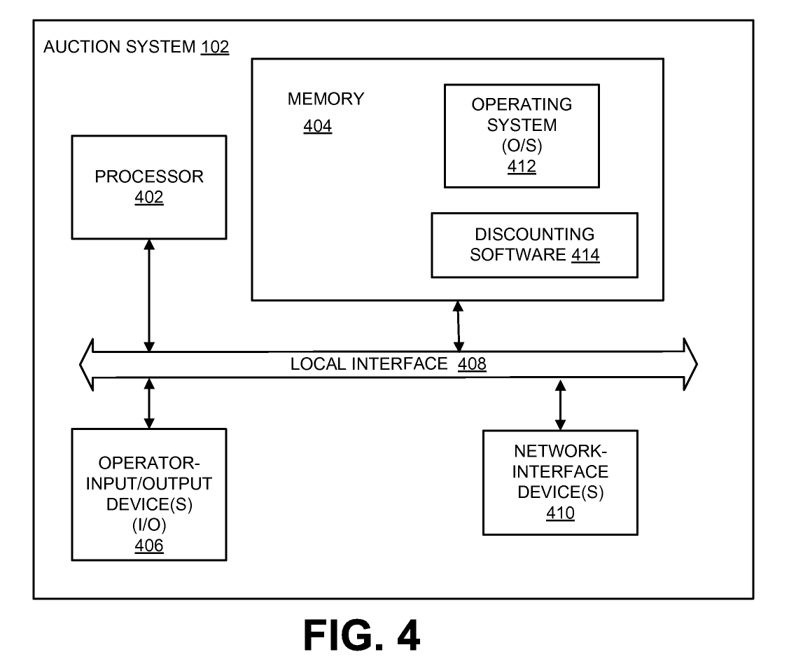

FIG. 4 is a block diagram illustrating a auction system 102 in accordance with exemplary embodiments. Note that some alternative embodiments of clustered auctioning may be implemented without an auction system 102. The auction system 102 includes a processor 402, memory 404, network interface device(s) 410, and one or more user input and/or output (I/O) device(s) 406 (or peripherals) that are communicatively coupled via a local interface 408.

The local interface 408 can be, for example but is not limited to, one or more buses or other wired or wireless connections, as is known in the art. The local interface 408 might have additional elements, which are omitted for simplicity, such as controllers, buffers (caches), drivers, repeaters, and receivers, to enable communications. Further, the local interface 408 might include address, control, and/or data connections to enable appropriate communications among the aforementioned components.

The processor 402 is a hardware device for executing software, particularly that stored in memory 404. The processor 402 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 404 can include any one or combination of volatile memory elements (e.g., RAM, such as DRAM, SRAM, SDRAM, etc.) and nonvolatile memory elements (e.g., ROM, flash memory, etc.). Moreover, the memory 404 might incorporate electronic, magnetic, optical, and/or other types of storage media. Note that the memory 404 can have a distributed architecture, where various components are situated remote from one another, but can be accessed by the processor 402.

The user I/O device(s) 406 includes input devices such as, for example but not limited to, a keyboard, mouse, scanner, microphone, a touch sensitive display etc. Furthermore, the user I/O device(s) 406 also include output devices such as, for example but not limited to, a printer, display, etc. The network interface device(s) 410 include, for example, a modem, a radio frequency (RF) or other transceiver, a telephonic interface, an Ethernet interface, a bridge, and/or a router.

Software stored in memory 404 may include one or more separate programs, each one of which comprises an ordered listing of executable instructions for implementing logical functions. In the example of FIG. 4, the software in the memory 404 includes operating system 412 and auction software 414. Among other things, the operating system 412 essentially controls the execution of the auction software 414 and provides scheduling, input-output control, file and data management, memory management, and communication control and related services.

The auction software 414 may be configured enable a clustered auction by for example, assigning parameter values to auction items and determining winner for the auction items based at least in part on such parameter values. The auction software 414 may also be configured to communicate with a customer device 104. The auction software 414 may be a source program, executable program (object code), script, or any other entity comprising a set of instructions to be performed. When implemented as a source program, the auction software 414 is translated via a compiler, assembler, interpreter, or the like, which may or may not be included within the memory 404, so as to operate properly in connection with the O/S 412. Furthermore, the auction software 414 can be written in one or more object oriented programming languages, which have classes of data and methods, or procedure programming languages, which have routines, subroutines, and/or functions.

While various embodiments of the systems and methods for clustered auctioning have been described, it will be apparent to those of ordinary skill in the art that many more embodiments and implementations are possible that are within the scope of this disclosure. Accordingly, the present systems and methods are not to be restricted except in light of the following claims and their equivalents.

What is claimed is:

1. A method comprising:
assigning respective parameter values to each of a plurality of auction items in an auction; and
determining a winner of at least one of the auction items responsive to a parameter value of another auction item among the plurality of auction items.

2. The method of claim 1, wherein the plurality of auction items comprise a first auction item, a second auction item, and a third auction item, the method further comprising:
determining a winner of the first auction item responsive to a parameter value assigned to the second auction item; and
determining a winner of the second auction item responsive to the parameter value assigned to the third auction item.

3. The method of claim 1, wherein the respective parameter values are based on respective monetary values of the plurality of auction items.

4. The method of claim 1, wherein a winner of an auction item having a highest parameter value is responsive to a parameter value of an auction item having a lowest parameter value.

5. The method of claim 1, wherein a winner of an auction item having a lowest parameter value is responsive to a parameter value of an auction item having a highest parameter value.

6. The method of claim 1, wherein each of the auction items comprises at least one of a product and a service.

7. The method of claim 1, wherein a participant in the auction is determined to be a winner of an auction item among the plurality of auction items based on a value of bid placed by the participant on the auction item.

8. The method of claim 1, wherein a participant in the auction is determined to be a winner of an auction item among the plurality of auction items based on an order in which the participant performed an action relative to other participants in the auction.

9. The method of claim 1, wherein the plurality of auction items are awards for encouraging participants in the auction to perform desired actions.

10. The method of claim 1, wherein the auction is a game of chance, and wherein a participant in the auction is determined to be a winner of an auction item among the plurality of auction items based at least in part on an outcome of a random event.

11. A system comprising:
a processor; and
memory comprising programming instructions configured to enable the processor to:
assign respective parameter values to each of a plurality of auction items in an auction; and
determine a winner of at least one of the auction items responsive to a parameter value of another auction item among the plurality of auction items.

12. The system of claim 11, wherein the plurality of auction items comprise a first auction item, a second auction item, and a third auction item, and wherein the programming instructions are further configured to:
determine a winner of the first auction item responsive to a parameter value assigned to the second auction item; and
determine a winner of the second auction item responsive to the parameter value assigned to the third auction item.

13. The system of claim 11, wherein the respective parameter values are based on respective monetary values of the plurality of auction items.

14. The system of claim 11, wherein a winner of an auction item having a highest parameter value is responsive to a parameter value of an auction item having a lowest parameter value.

15. The system of claim 11, wherein a winner of an auction item having a lowest parameter value is responsive to a parameter value of an auction item having a highest parameter value.

16. The system of claim 11, wherein each of the auction items comprises at least one of a product and a service.

17. The system of claim 11, wherein a participant in the auction is determined to be a winner of an auction item among the plurality of auction items based on a value of bid placed by the participant on the auction item.

18. The system of claim 11, wherein a participant in the auction is determined to be a winner of an auction item among the plurality of auction items based on an order in which the participant performed an action relative to other participants in the auction.

19. The system of claim 11, wherein the plurality of auction items are awards for encouraging participants in the auction to perform desired actions.

20. The system of claim 11, wherein the auction is a game of chance, and wherein a participant in the auction is determined to be a winner of an auction item among the plurality of auction items based at least in part on an outcome of a random event.
